(19) United States
(12) Patent Application Publication
(10) Pub. No.: US 2011/0074335 A1
(43) Pub. Date: Mar. 31, 2011

(54) WIRELESS COMMUNICATION MODULE

(75) Inventor: Peng Sen Chen, Shinchu City (TW)

(73) Assignee: ISSC TECHNOLOGIES CORP., Shinchu City (TW)

(21) Appl. No.: 12/886,916

(22) Filed: Sep. 21, 2010

Related U.S. Application Data
(60) Provisional application No. 61/247,063, filed on Sep. 30, 2009.

(51) Int. Cl. H01M 10/46

(52) U.S. Cl. 320/101

(57) ABSTRACT

A wireless communication module includes a photoelectric conversion unit, a battery, and a communication unit. The photoelectric conversion unit is used to receive a light source, convert the light source into an electrical energy, and output the electrical energy. The battery is electrically connected to the photoelectric conversion unit, and is used to store the electrical energy. The communication unit is electrically connected to the battery, and is powered by the electrical energy. When the wireless communication module is applied to a communication device, a solar energy source is used as a source of an electrical power, and as the photoelectric conversion unit and the communication unit are integrated into a system on chip (SOC), an overall volume of the communication device is effectively reduced.

### CROSS-REFERENCE TO RELATED APPLICATIONS

This non-provisional application claims priority under 35 U.S.C. §119(e) on Patent Application No(s). 61/247,063 filed in the United States on Sep. 30, 2009, the entire contents of which are hereby incorporated by reference.

### BACKGROUND OF THE INVENTION

1. Field of the Invention

The present invention relates to a wireless communication module, and more particularly, to a wireless communication module having a photoelectric conversion unit, so as to convert a received light source to an electrical energy required by execution of a communication unit.

2. Related Art

Along with the ever changing technology, due to the portable convenience, the cell phone gradually becomes an indispensable part in the life of modern people, and the popularization of the cell phone is also quickly expanded. During operations, when the cell phone receives messages, sends messages, performs displaying, and functions as a loudspeaker, a power source is required by the cell phone to perform functions above. Here, according to different charging capacities, a battery installed in the cell phone needs to be replaced after certain using time, or the cell phone has to be directly charged, so as to refill the electrical power and continue the operation time of the cell phone.

A conventional cell phone charger is externally connected to a household alternating current (AC) power source through a power source line, so as to rectify the household AC power source to a direct current (DC) power source, and charge the cell phone or the battery. As the using amount of the cell phone and the using amount of the power source are rapidly increased, the charging manner wastes the global energy sources. In addition, due to the winding and the twisting of the power source line, the conventional charger has problems of large portable volume when being taken out, and inconveniences for the user.

Therefore, as the new energy sources are developed and the global environmental protection concept is increasingly aroused, more and more solar energy is developed for being used in daily life. For example, some designers use the solar energy as a source of the electrical power for charging the cell phone. However, in order to charge the cell phone, sufficient electrical energy is required. In order to obtain the electrical energy being sufficient for the operation of the cell phone, usually a solar panel having a large area is used.

Design requirements of the cell phone are light, thin, short, and small, such that the cell phone is portable. However, when the solar panel having the large area is integrated into the cell phone, an overall volume of the cell phone becomes larger, which goes against to the concept of designing the cell phone. Therefore, a heretofore unaddressed need exists in the art to address the aforementioned deficiencies and inadequacies.

### SUMMARY OF THE INVENTION

In view of the above, the present invention is a wireless communication module, applicable to a cell phone, a notebook computer, a multi-media player (Ipod), or other communication devices. In the wireless communication module according to the present invention, the communication device may be charged by a solar energy and a DC power source, and an overall volume of the communication device is effectively reduced, thus achieving the portability obtained after a solar panel is effectively integrated into the communication device.

The present invention provides a wireless communication module, which comprises a photoelectric conversion unit, a battery, and a communication unit. The photoelectric conversion unit is used to receive a light source, convert the light source into an electrical energy, and output the electrical energy. The battery is electrically connected to the photoelectric conversion unit, and stores the electrical energy. The communication unit is electrically connected to the battery, and is powered by the electrical energy.

In the wireless communication module according to the present invention, the communication unit and the photoelectric conversion unit are integrated into a system on chip (SOC).

The wireless communication module according to the present invention further comprises a charging unit, for supplying a DC power source to the battery or the communication unit.

In the wireless communication module according to the present invention, a switch is disposed between the communication unit, the charging unit, and the battery, and the communication unit is selectively switched to either a first conduction path or a second conduction path.

Therefore, in the wireless communication module according to the present invention, the photoelectric conversion unit converts the solar energy source to the electrical energy, and the battery stores the electrical energy, such that the communication unit powered by the electrical energy executes a communication function. Besides, in the wireless communication module according to the present invention, the DC power source may be selectively directly supplied to the communication unit by the charging unit. Therefore, when the wireless communication module according to the present invention is applied to the communication device, the consumption of the energy source is effectively reduced, and the overall volume of the communication device is saved.

### BRIEF DESCRIPTION OF THE DRAWINGS

The present invention will become more fully understood from the detailed description given herein below for illustration only, and thus are not limitative of the present invention, and wherein:

FIG. 1 is a functional block diagram of a wireless communication module according to a first embodiment of the present invention;

FIG. 2 is a functional block diagram of a wireless communication module according to a second embodiment of the present invention;

FIG. 3 is a schematic view of an internal circuit of a photoelectric conversion unit according to an embodiment of the present invention;

FIGS. 4A and 4B are respectively schematic inside views of a current stabilizing element according to an embodiment of the present invention;

FIG. 5 is a functional block diagram of a wireless communication module according to a third embodiment of the present invention; and

FIG. 6 is a functional block diagram of a wireless communication module according to a fourth embodiment of the present invention.

### DETAILED DESCRIPTION OF THE INVENTION

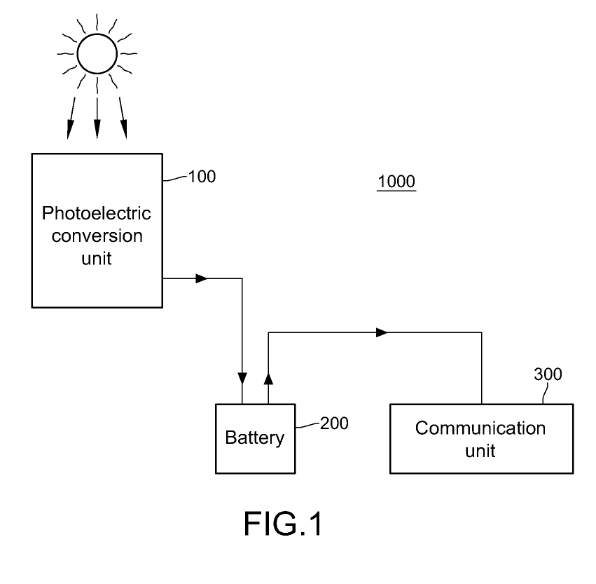

FIG. 1 is a functional block diagram of a wireless communication module according to a first embodiment of the present invention. In the description in the following, the wireless communication module is applied to a cell phone, for serving as the description of an embodiment of the present invention. However, the wireless communication module according to the embodiment of the present invention may be further applied to a personal digital assistant (PDA), a notebook computer, a multi-media player (Ipod), or other communication devices, in which types of the communication devices are not used to limit the scope of the present invention.

As shown in FIG. 1, the wireless communication module 1000 comprises a photoelectric conversion unit 100, a battery 200, and a communication unit 300. The photoelectric conversion unit 100 is used to receive a light source, convert the light source into an electrical energy, and output the electrical energy, in which the light source may be, but not limited to, a solar energy source. The battery 200 is electrically connected to the photoelectric conversion unit 100, and is used to store the electrical energy output by the photoelectric conversion unit 100. The communication unit 300 is electrically connected to the battery 200, and is powered by the electrical energy stored by the battery 200, such that the communication unit 300 executes a communication function, in which the communication unit 300 may be blue tooth (BT), wireless fidelity (Wi-Fi), or other wireless communication integrated circuit chips (ICs).

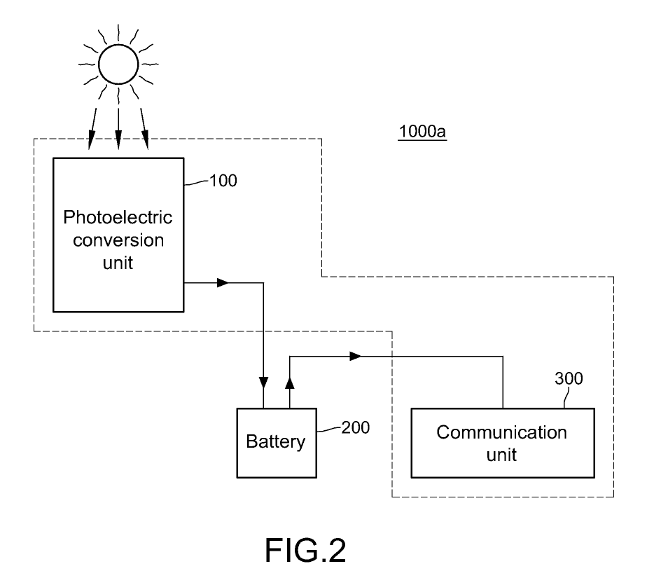

In order to save the overall volume of the communication device (for example, the cell phone), as shown in FIG. 2, a functional block diagram of the wireless communication module according to a second embodiment of the present invention, the photoelectric conversion unit 100 and the communication unit 300 of the wireless communication module 1000a are selectively integrated into an SOC, so as to effectively integrate a system and reduce the overall volume of the communication device without affecting the communication function.

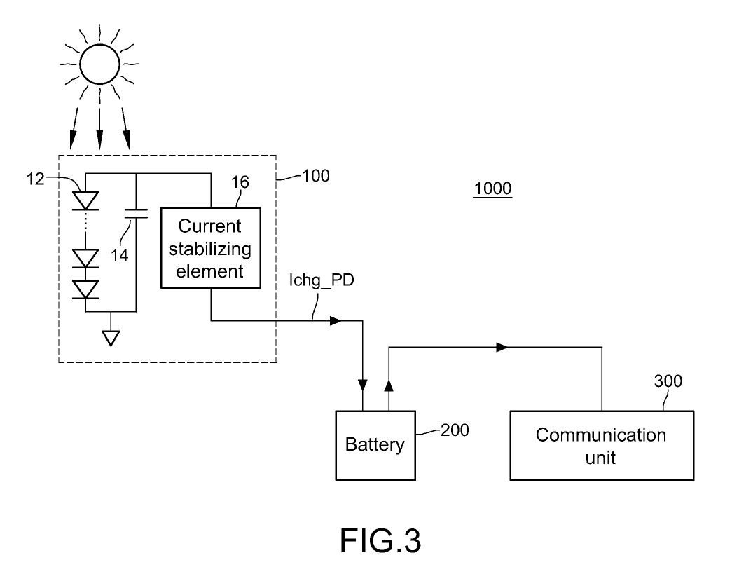

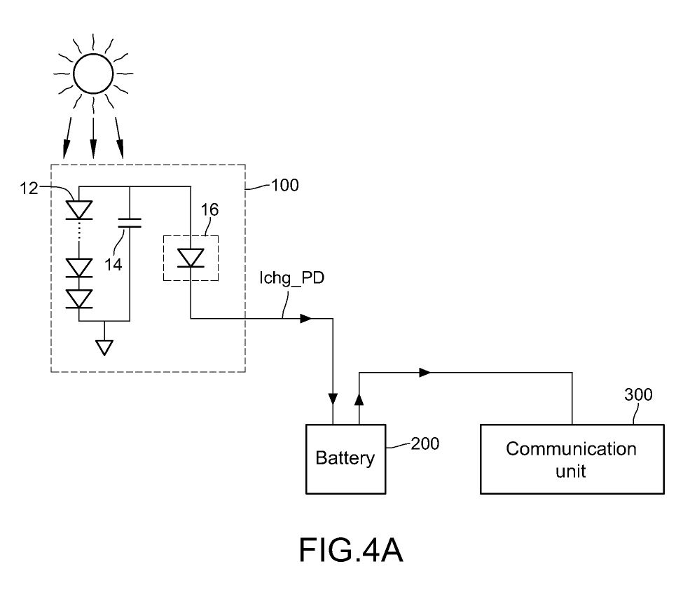

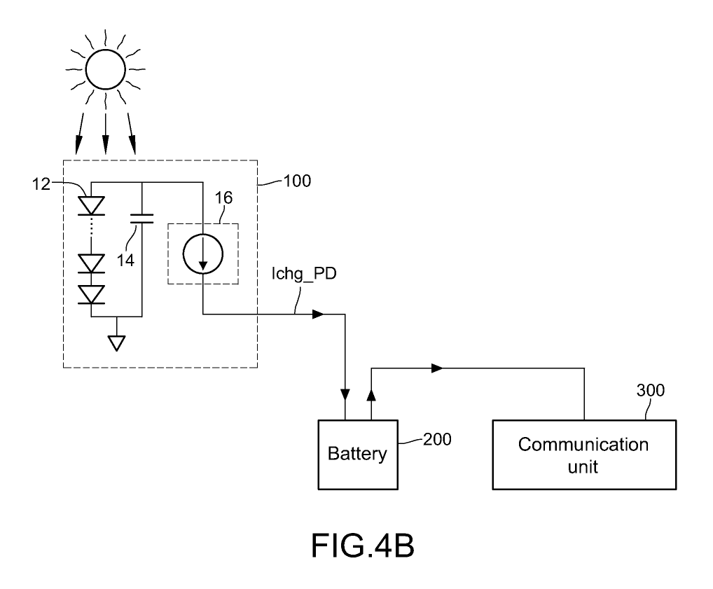

FIG. 3 is a schematic view of an internal circuit of the photoelectric conversion unit according to an embodiment of the present invention. The photoelectric conversion unit 100 comprises at least one photo diode 12, a capacitor 14, and a current stabilizing element 16. The photo diode 12 may perform a photoelectric conversion procedure, that is to say, the photo diode 12 may convert the received light source into the electrical energy, and output the electrical energy. Then, the capacitor 14 connected in parallel with the photo diode 12 may store the electrical energy output by the photo diode 12. The current stabilizing element 16 is electrically connected between the capacitor 14 and the battery 200, such that the current stabilizing element 16 converts the electrical energy stored by the capacitor 14 to a relatively stable current source, so as to supply a constant current Ichg_PD, for the battery 200 to store therein. The current stabilizing element 16 may be a diode as shown in FIG. 4A, or a current source in FIG. 4B.

According to the embodiment of the present invention, numbers of the photo diodes 12 may be determined according to actual circuit specifications, and are not used to limit the scope of the present invention. When the wireless communication module according to the embodiment of the present invention is applied to the cell phone, for example, and the battery 200 is charged to 4.2 volts, the numbers of the serially connected photo diodes 12 may be 8 to 9.

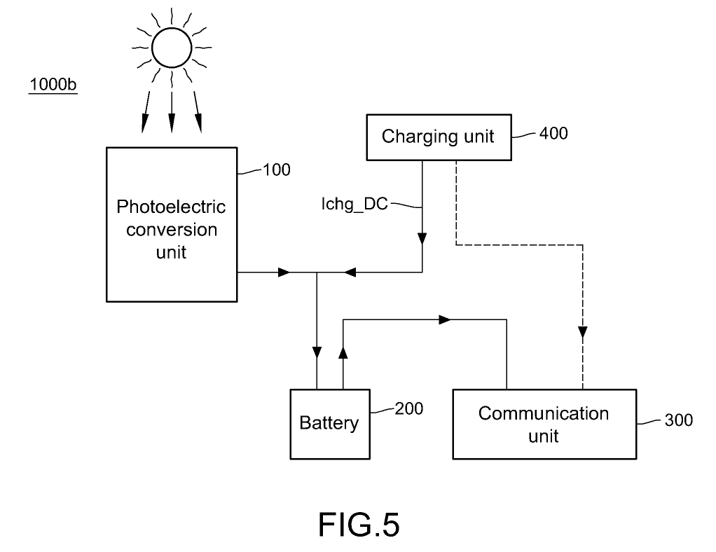

FIG. 5 is a functional block diagram of the wireless communication module according to a third embodiment of the present invention. In addition to the photoelectric conversion unit 100, the battery 200, and the communication unit 300, the wireless communication module 1000b further comprises a charging unit 400, which supplies a DC power source Ichg_DC to the battery 200 or the communication unit 300. That is to say, the DC power source Ichg_DC is not only used to charge the battery 200, so as to serve as a source of an electrical power of the communication unit 300, but also directly supplies the electrical power to the communication unit 300.

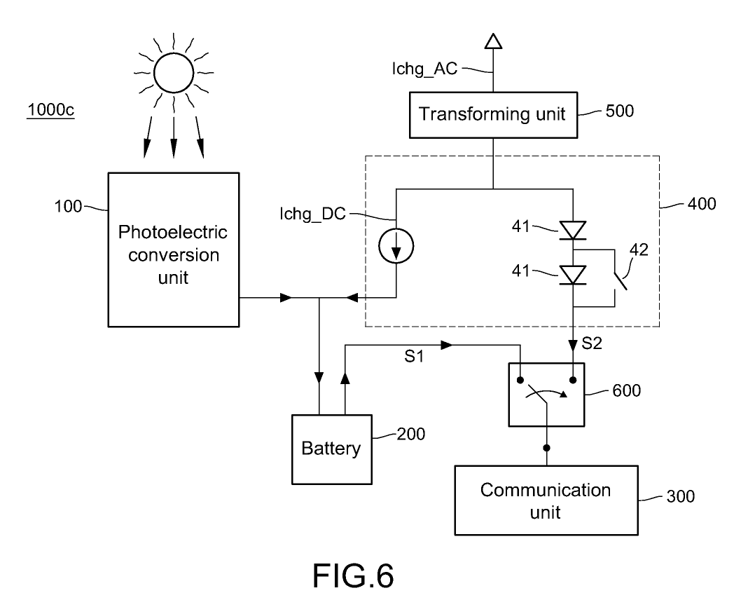

Accordingly, referring to FIG. 6, a functional block diagram of the wireless communication module according to a fourth embodiment of the present invention is shown. A switch 600 is disposed between the communication unit 300, the charging unit 400, and the battery 200, and the communication unit 300 is selectively switched to either a first conduction path S1 or a second conduction path S2. When the switch 600 is switched to the first conduction path S1, the battery 200 is electrically conducted to the communication unit 300, so as to supply the electrical power to the communication unit 300 for executing its communication function. Here, the electrical power supplied by the battery 200 may comprise the electrical energy converted by the photoelectric conversion unit 100, and the DC power source Ichg_DC supplied by the charging unit 400.

When the switch 600 is switched to the second conduction path S2, that is, the charging unit 400 is electrically conducted to the communication unit 300, and supplies the electrical power to the communication unit 300 for executing its communication function. Here, the DC power source Ichg_DC supplied by the charging unit 400 may be adjusted according to continuous flow diodes 41 and a switching unit 42, and is directly input to the communication unit 300, for supplying the source of the electrical energy required by operation of the communication unit 300.

As shown in FIG. 6, the charging unit 400 is further connected to a transforming unit 500, in which the transforming unit 500 may be, but not limited to, a transformer, a linear converter, or a switch converter. The transforming unit 500 receives an AC power source Ichg_AC, and converts the AC power source Ichg_AC to the DC power source Ichg_DC subsequently output to the charging unit 400. Therefore, according to the fourth embodiment of the present invention, the wireless communication module 1000c may also be applied to a household AC power source, and after being rectified and converted by the transforming unit 500, the AC power source is then turned into the DC power source that can be supplied to the operation of the communication unit 300.

To sum up, in the wireless communication module according to the first embodiment of the present invention, the photoelectric conversion unit receives the light source and performs the photoelectric conversion, and the battery stores the electrical energy, such that the electrical energy serves as the source of the electrical power of the subsequent operation of the communication unit. Next, according to the third embodiment of the present invention, in order to increase the electrical energy stored by the battery, the wireless communication module further has a charging unit, so as to supply the additional DC power source, for being stored by the battery or being directly supplied to the communication unit. Therefore, when the wireless communication module according to the embodiment of the present invention is applied to the communication device, the consumption of the energy source is saved, and as the communication unit and the photoelectric conversion unit are integrated into the SOC (the second embodiment), the overall volume of the communication device when being fabricated is reduced.

What is claimed is:

1. A wireless communication module, comprising:
a photoelectric conversion unit, for receiving a light source, and converting the light source into an electrical energy, and outputting the electrical energy;
a battery, electrically connected to the photoelectric conversion unit, for storing the electrical energy; and
a communication unit, electrically connected to the battery, and powered by the electrical energy.

2. The wireless communication module according to claim 1, wherein the communication unit and the photoelectric conversion unit are integrated into a system on chip (SOC).

3. The wireless communication module according to claim 1, further comprising a charging unit, for supplying a direct current (DC) power source to the battery or the communication unit.

4. The wireless communication module according to claim 3, wherein the charging unit is further connected to a transforming unit, and the transforming unit converts an alternating current (AC) power source to the DC power source.

5. The wireless communication module according to claim 3, wherein a switch is disposed between the communication unit, the charging unit, and the battery, and the communication unit is selectively switched to either a first conduction path or a second conduction path.

6. The wireless communication module according to claim 5, wherein the battery is electrically conducted to the communication unit through the first conduction path, such that the communication unit executes a communication function.

7. The wireless communication module according to claim 5, wherein the charging unit is electrically conducted to the communication unit through the second conduction path, such that the communication unit executes a communication function.

8. The wireless communication module according to claim 1, wherein the photoelectric conversion unit comprises at least one photo diode, for receiving the light source, converting the light source into the electrical energy, and outputting the electrical energy.

9. The wireless communication module according to claim 8, wherein the photoelectric conversion unit further comprises a capacitor, connected in parallel with the photo diode, for storing the electrical energy.

10. The wireless communication module according to claim 9, wherein the photoelectric conversion unit further comprises a current stabilizing element, electrically connected between the capacitor and the battery, for supplying a constant current to the battery.

11. The wireless communication module according to claim 10, wherein the current stabilizing element is a diode.

12. The wireless communication module according to claim 10, wherein the current stabilizing element is a current source.
